(19) United States
(12) Patent Application Publication
(10) Pub. No.: US 2003/0005147 A1
(43) Pub. Date: Jan. 2, 2003

(54) IP/HDLC addressing system for replacing frame relay based systems and method therefor

(76) Inventors: Daniel Albert Enns, Phoenix, AZ (US); Naresh Kumar Jain, Tempe, AZ (US); Robert L. McCollum, Chandler, AZ (US)

Correspondence Address: WEISS & MOY PC, 4204 NORTH BROWN AVENUE, SCOTTSDALE, AZ, 85251, US

(21) Appl. No.: 09/896,325

(22) Filed: Jun. 29, 2001

(51) Int. Cl. G06F 15/16; G06F 15/173

(52) U.S. Cl. 709/238; 709/236; 709/219

(57) ABSTRACT

A network system with a STAR topology allows single hop connectivity between sites. The system has a hub site and a plurality of remote sites. A first channel is used for sending data from the hub site to all of the plurality of remote sites. A plurality of second channels are used for transmitting data from each of the plurality of remote sites to the hub site and for transmitting data between the plurality of remote sites. In the system, call control and management between the hub site and the remote sites and between different remote sites use Internet protocol (IP) addressing for identification.

### BACKGROUND OF THE INVENTION

1. Field of the Invention

This invention relates to the field of networking systems and methods therefor and, more specifically, to an Internet Protocol (IP) addressing system for replacing traditional frame relay systems operating over a satellite and a method therefor.

2. Description of the Prior Art

Present-day network systems communicate through a variety of protocols and channels in order to interconnect computers, telephony devices and other systems that required data or voice communications. Quality of Service (QoS) is a designator that is used in network systems to assign or request desirable data transfer characteristics, such as delay and bandwidth characteristics for a given channel. Service quality can be assigned on a per-user basis to provide several levels of interconnect performance conforming to desired performance levels. Users may be charged fees for different performance levels. For example, a business connection or Internet Service Provider (ISP) serving multiple users will have a higher desired performance level than an individual residential customer, and the fees for such performance can be assigned accordingly.

QoS levels are typically set within a network by a configuration manager, which can be coupled to the network or coupled to a network component such as a router. The configuration manager is a program running on a computer that permits setting of network addresses such as Internet Protocol (IP) addresses, QoS requirements for a given connection between addresses and protocols to be used for communication between networked devices.

There are many instances where a customer will require a satellite network to provide a number of real-time and non real-time services including voice, data, and video. Currently, such networks use frame relay as the underlying transport due to its ability to assign different levels of service to the different pipeline flows.

A typical satellite network has a central site or hub that transmits the aggregate carrier consisting of all Frame Relay circuits to all the remote sites. The remote sites receive this aggregate carrier and demultiplex the circuits of interest to them.

Each remote site transmits a simplex carrier for all its frame relay circuits going back to the central site. Each frame relay circuit is assigned a committed circuit rate and a maximum burstable rate depending on the application. For example, a voice circuit may have a rate of 32 kbits/s with a maximum rate also set to 32 kbits/s. However, for emails and other non-real time data transfers, the circuit may be set to 0 (or some other low value) with a maximum rate set to 64 kbits/s. This will allow email transfers whenever bandwidth is available. For satellite networks, in addition to the satellite modems and the RF equipment, a frame relay solution requires Frame Relay Access Devices (FRADs) at each site, thereby significantly increasing the network cost.

Therefore, a need existed to provide an improved network communication system. The improved network communication system will use HDLC as the link layer transport mechanism instead of using traditional frame relay. The improved network communication system will use an addressing mechanism based on HDLC addresses and IP addresses to replace virtual channels provided by the Data Link Connection Identifier (DLCI) mechanism of the Frame Relay. The improved network communication system must further provide a lower cost alternative than a frame relay based system.

### SUMMARY OF THE INVENTION

In accordance with one embodiment of the present invention, it is an object of the present invention to provide an improved network communication system.

It is another object of the present invention to provide an improved network communication system that will use HDLC as the transport mechanism instead of using Frame Relay.

It is yet another object of the present invention to provide QoS similar to Frame Relay Committed Information Rate (CIR) and mechanism similar to DLCI using a combination HDLC addressing and IP addressing.

It is still another object of the present invention to provide an improved network communication system that provides a lower cost alternative than a frame relay based system.

### BRIEF DESCRIPTION OF THE PREFERRED EMBODIMENTS

In accordance with one embodiment of the present invention a network system is disclosed. The network system has a STAR topology. The network has a hub site and at least one remote site. In the network, call control and management between the hub site and the remote site use Internet Protocol (IP) addressing for identification thereby allowing only a desired remote site to read data transmitted.

In accordance with another embodiment of the present invention a network system is disclosed. The network system has a STAR topology and allows single hop connectivity between sites. The system has a hub site and a plurality of remote sites. A first channel is used for sending data from the hub site to all of the plurality of remote sites. A plurality of second channels are used for transmitting data from each of the plurality of remote sites to the hub site and for transmitting data between the plurality of remote sites. In the system, call control and management between the hub site and the remote sites and between different remote sites use Internet Protocol (IP) addressing for identification.

In accordance with another embodiment of the present invention a method for allowing a network system having STAR topology to perform single hop connectivity between remote sites is disclosed. The method comprises the steps of: providing a single hop server at a hub site of the network system; providing a first remote modem at each remote site for continuously receiving data from the hub site and for transmitting data when required; providing a second remote modem at each remote site that receives data from a second remote site for receiving data sent from a different remote site; configuring the network so call control and management between the hub site and the remote sites and between different remote sites use Internet Protocol (IP) addressing for identification; and configuring a direct channel between remote sites that are communicating to transmit the data.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is a block diagram depicting a network communication system within which the present invention may be embodied.

FIG. 2 is a pictorial diagram depicting a configuration manager table for a hub site modem in accordance with a preferred embodiment of the invention.

FIG. 3 is a pictorial diagram depicting a configuration manager table for a remote site modem in accordance with a preferred embodiment of the present invention.

FIG. 4 a block diagram depicting another embodiment of a network communication system within which the present invention may be embodied.

FIG. 5 a pictorial diagram depicting a configuration manager table for a remote site modem in accordance with a preferred embodiment of the present invention.

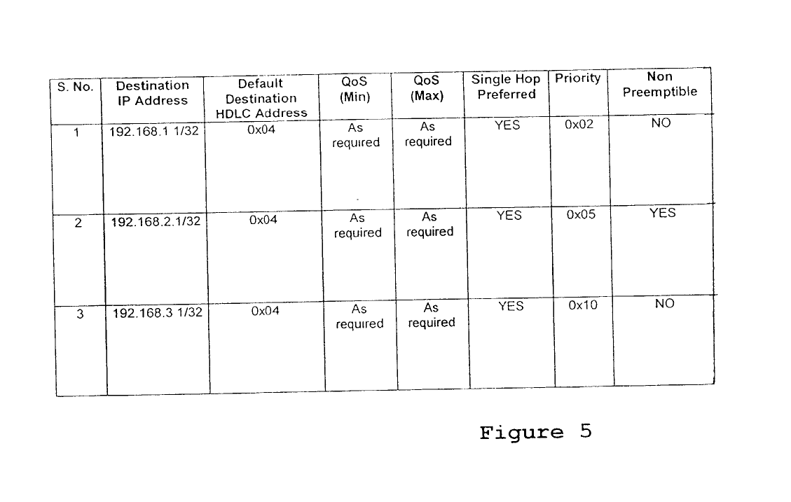

### DETAILED DESCRIPTION OF THE PREFERRED EMBODIMENT

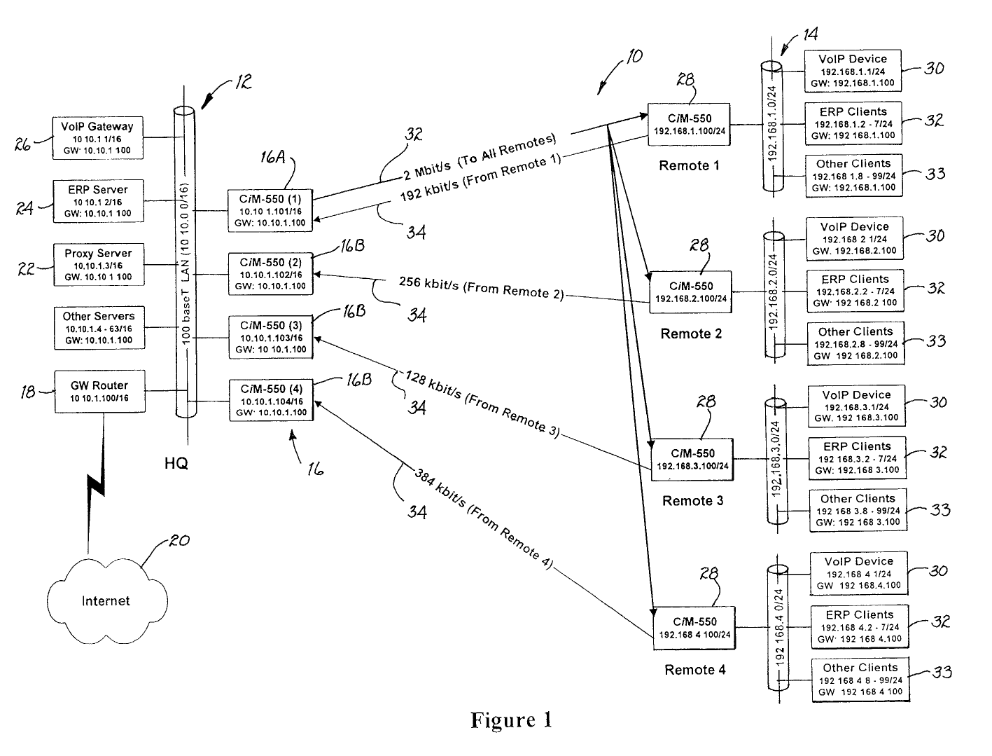

Referring to the FIG. 1, a network communication network 10 (hereinafter network 10) is shown within which the present invention may be embodied. The network 10 has a STAR topology and uses IP addressing for communication between devices. The network 10 may be any type of network. However, the network 10 is generally a satellite network.

The network 10 has a hub site 12 and multiple remote sites 14. The hub site 10 has one or more IP modems 16. A first IP modem 16A is used to transmit an aggregate carrier signal to all the remote sites 14. The remaining IP modems 16B are used to receive a return carrier signal from the remote sites 14. The hub site 12 may be coupled to the Internet 20. The hub site 12 will use a router 18 and a proxy server 22 to connect to and transfer data between the hub site 12 and the Internet 20. The proxy server 22 may further be used as a firewall mechanism. The proxy server 22 may act as a barrier to prevent hackers from accessing the network 10. The proxy server 22 can be used to hide IP addresses of hardware within the network 10 from the Internet 20 since the hardware may not have official registered network numbers.

The hub site 12 may further have an ERP server 24 and a Voice over IP (VoIP) gateway 26. The ERP server 24 is used to support customer's business applications. The VoIP gateway 26 is used to connect the network 10 using Voice-over-IP (VoIP) to the standard public switch telephone network.

Each remote site 14 will have an IP modem 28. The IP modem 28 is used to receive data from the hub site 12 and transmit data back to the hub site 12. Each remote site 14 may have one or more different clients/devices coupled thereto. In the embodiment depicted in FIG. 1, each remote site 14 has a VoIP device 30, ERP clients 32, as well as other clients 33

The network 10 has a first carrier 32. The first carrier 32 transmits an aggregate carrier signal to all of the remote sites 14. A satellite is generally used to transfer the data. The satellite contains a transmitter-receiver, transponder or other suitable circuitry for receiving and transmitting information using an antenna. The first carrier 32 is configured to send no more than a QoS maximum amount of data. In the embodiment depicted in FIG. 1, the first carrier 32 is configured to send an aggregate carrier of 2 Mbits/s. The network 10 further has a plurality of second carriers 34. The second carriers 34 are used to transmit data back to the hub site 12. Each of the second carriers 34 will have a QoS minimum and a QoS maximum. The sum of all the QoS minimums of the second carriers 34 must not exceed the QoS maximum of the first carrier 32.

The network 10 uses a communication protocol for call control and management between the hub site 12 and the remote sites 14. The communication protocol is UDP/IP based using IP addresses for identification. HDLC encapsulation is used at the link layer.

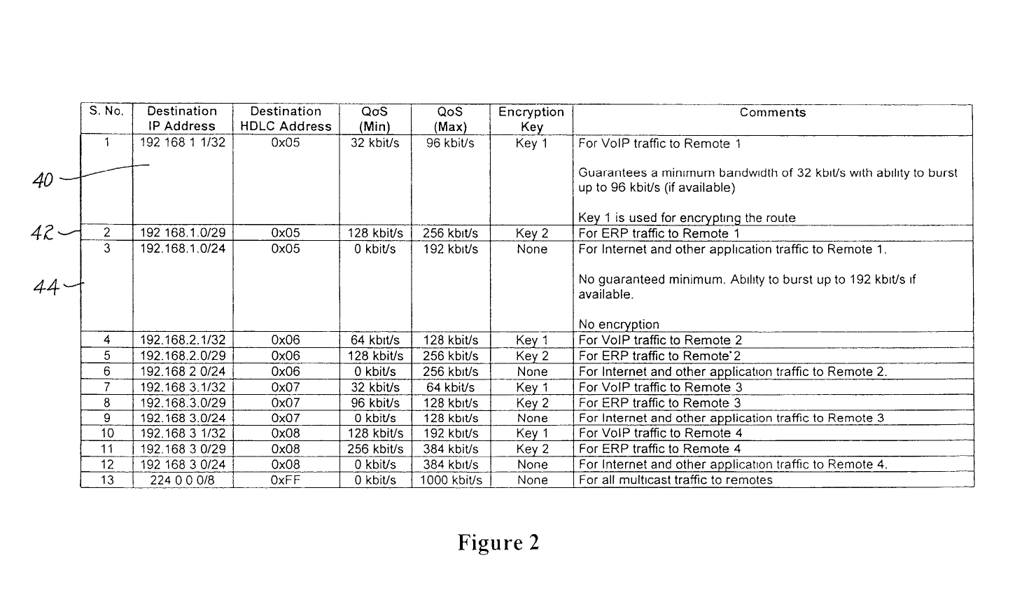

Any IP modem which is used to transmit data maintains a configuration table. The first IP modem 16A of the hub site 12 maintains configuration information used for distributing the network information to the remote sites 14. Referring now to FIG. 2, a pictorial diagram depicting a configuration table in accordance with a preferred embodiment of the invention is shown. The main configuration table of the first IP modem 16A has a listing of all the destination addresses for different elements/devices at the different remote sites 14. For example, the main configuration table of the first IP modem 16A list the IP addresses 40 for VoIP traffic to the first remote site 14A, the IP address 42 for ERP traffic to the first remote site 14A, and the IP address 44 for other traffic to the first remote site 14A. Each channel is programmed with a destination IP address and a destination HDLC address. The configuration table will also show the minimum available bandwidth of each channel and a guaranteed maximum bandwidth. The main configuration table will even show encryption capability of each channel. The first IP modem 16A is configured to support two separate keys for encryption. A particular channel may be configured to use Key 1, Key 2, a randomly selected key (Key 1 or Key 2) using an IP datagram basis, or no encryption at all.

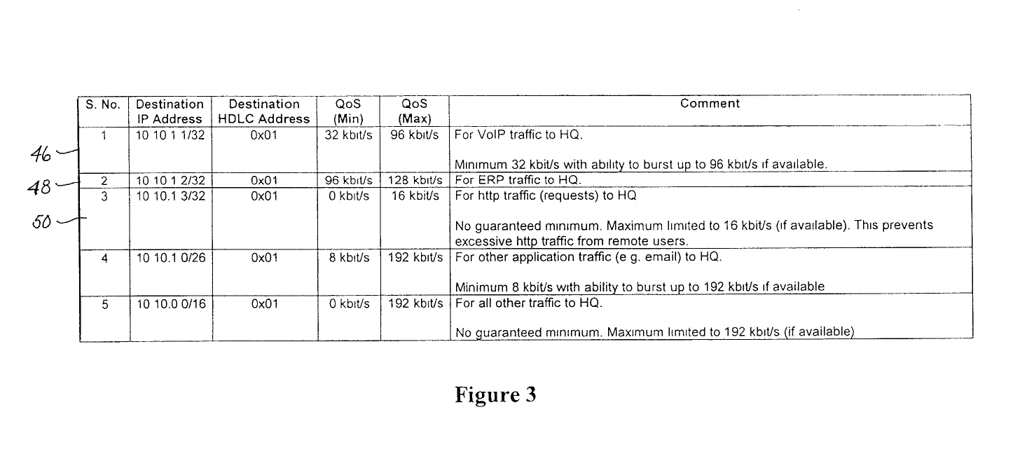

Each of the other IP modems 28 at each remote site 14 is also configured to transmit data to the hub site 12. Referring to FIG. 3, a pictorial diagram depicting a configuration table in accordance with a preferred embodiment of the invention is shown. The configuration table of the IP modem 28A of the first remote site 14A has a listing of all the destination addresses for different elements/devices at the hub site 12. For example, the configuration table of the IP modem 28A list the IP addresses 46 for VoIP traffic to the hub site 12, the IP address 48 for ERP traffic to the hub site 12, and the IP address 50 for other traffic to the hub site 12. Each channel is programmed with a destination IP address and a destination HDLC address. The configuration table will also show the minimum available bandwidth of each channel and a guaranteed maximum bandwidth. The other IP modems 28 at the other remote sites 14 are configured in a similar manner.

The network 10 uses a communication protocol for call control and management between the hub site 12 and the remote sites 14. The communication protocol is UDP/IP based using IP addresses for identification. HDLC encapsulation is used at the link layer. All traffic to the remote sites 14 are transmitted by the first carrier 32 by the first IP modem 16A of the hub site 12. Traffic flow within the first carrier is identified by the IP/HDLC address assigned. Each traffic flow is individually rate controlled based on the QoS minimum and maximum. Each IP modem 28 at the different remote sites 14 filters the incoming traffic by the IP/HDLC address. This prevents traffic destined to one remote site 14 from being transmitted on another remote site's 14 LAN. Traffic flow from a remote site 14 to the hub site 12 proceeds in a similar manner. Traffic flow within a second carrier 34 is identified by the IP/HDLC address assigned. The traffic flow is individually rate controlled based on the QoS minimum and maximum.

### Operation—Traffic Flow from the Hub Site to a Remote Site

Referring again to FIG. 2, each channel may be configured to transmit data to a certain destination address and HDLC address. As may be seen in FIG. 2, channel 1 is configured to transmit data to a destination address 192.168.1.1/32 and HDLC address 0x05. The first section of the destination address will define what remote site 14 will be able to read the data. The second portion of the destination address will define a sub-network 40 within the remote site 14. The remainder of the IP address defines a range of host addresses within the sub-network 40.

The present network 10 further allows one to configure the rate of data transfer. One may bound the data transfer rate by setting a minimum and a maximum data transfer rate for each channel. One may even configure a channel to transmit encrypted data.

### Traffic Flow Between Remote Sites

Due to the STAR topology of the network 10, if traffic is destined from a remote site 28 to another remote site 28, the traffic has to be retransmitted by the hub site 12. This has two problems. First, there is a time delay problem. Since traffic flows from the remote site 14 to the hub site 12 and then from the hub site 12 to another remote site 14, there is a time delay that is more than doubled than direct traffic flow. Second, since multiple channels are used, the bandwidth requirement is doubled. These problems may be tolerated for infrequent store and forward traffic such as emails. However, for real time applications that requires low latency such as VoIP or video conferencing, or other applications that need to transfer large amounts of data, a double hop connection is unacceptable.

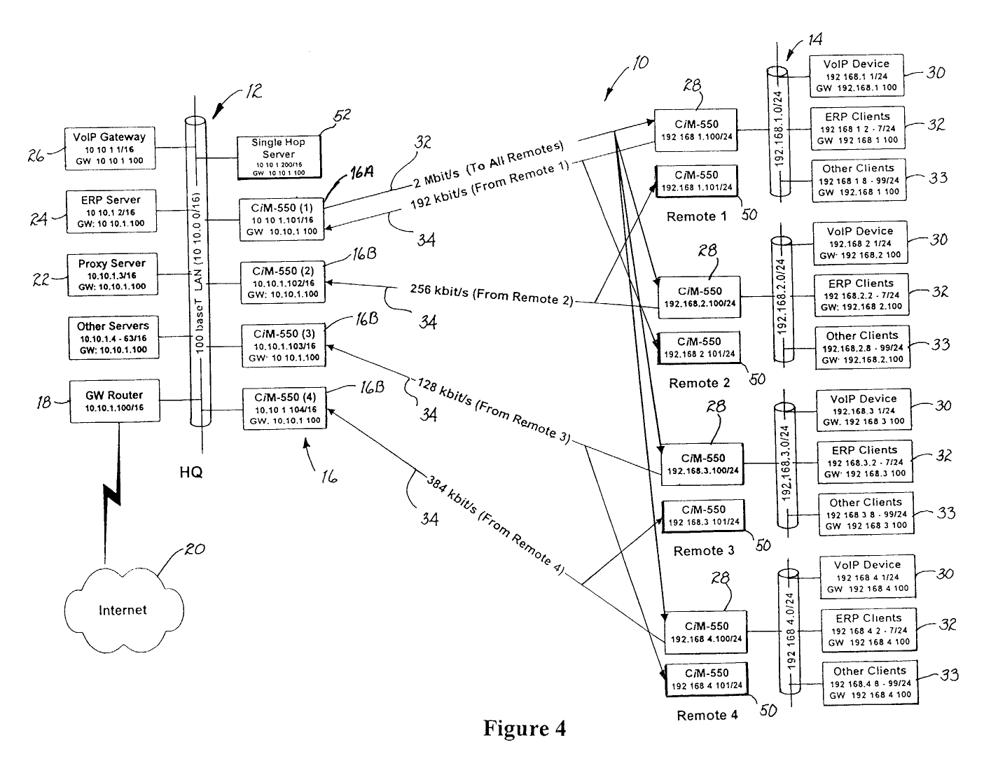

Referring now to FIG. 4 wherein like numbers and symbols represent like elements, another embodiment of the system 10 is shown. This embodiment is similar to the previous embodiment. The main difference is the addition of a receiver IP modem 50 at each remote site 14 and the addition of a single hop server 52 at the hub site 12. Each additional receiver IP modem 50 will be given a unique receiver IP address. The single hop server 52 will also be given a unique IP address. In addition to the configuration table shown in FIG. 3, each remote site 14 will be configured with the additional information as shown in FIG. 4 to include remote specific routes. These routes are configured to send traffic from a first remote site 14 to another remote site 14.

Initially, all the remote sites 14 are configured to route all the traffic via the hub site 12. However, once configured, the system 10 is enabled for on demand single hop connectivity. Thus, for example, if traffic from a first remote site 14 is sent to a second remote site 14, the traffic is sent via the hub site 12. However, the system 10 is also enabled for on demand single hop connectivity. When the data destined for an IP address of the second remote site 14 is received, the application client running on the IP modem 28 of the first remote site 14 recognizes that a single hop connection is preferred. The IP modem 28 of the first remote site 14 sends a message to the single hop server 52 requesting a single hop connection to the receiver IP modem 50 of the second remote site 14. In the mean time, the IP modem 28 of the first remote site 14 continues to send data to the second remote site 14 using existing routes (i.e., via the hub site 12). The single hop server 52, on receiving the single hop request checks to see if the second remote site 14 has a receiver IP modem 50 that is already tuned to the carrier being transmitted by the first remote site 14. If it does, and there are no administrative restrictions, the single hop server 52 selects an HDLC address from the available ranges. The single hop server 52 configures the receiver IP modem 50 of the second remote site 14 to add the HDLC address for receive and configures the IP modem 28 of the first remote site 14 to start using the new HDLC address for that route. If the receiver IP modem 50 is already configured to receive the maximum HDLC addresses that it is capable of handling, the single hop server 52 uses one of the existing HDLC addresses filtered by the receiver IP modem 50 and configures the transmit end to use that HDLC address for the new route, otherwise, it checks to see if an additional receiver IP modem 50 is available at the second remote site 18. If there is an additional receiver IP modem 50, then the single hop server 52 selects an HDLC address from the available ranges. The single hop server 52 configures the receiver IP modem 50 of the second remote site 14 to add the HDLC address for receive and configures the IP modem 28 of the first remote site 14 to start using the new HDLC address for that route. If there is no existing connection and no available receiver IP modem 50 at the second remote site 14, and if the priority of the new request is higher than that of the existing connection(s) to the receiver IP modem 50 at the second remote site 14, the single hop server 52 may preempt (subject to any administration restriction) the existing connection and allow the new connection to proceed. The preempted connection reverts to using the operator-configured routes (i.e., double hop via the hub site 12). If the new request has a lower priority, or if the existing connection is non-preemptible, the single hop server 52 will queue the request. It will keep checking for the availability of the receiver IP modem 50. As soon as one becomes available, the single hop server 52 will proceed to set up the single hop connection. While the request is queued, the remote to remote traffic pertaining to that connection will keep transiting via the hub site 12 (i.e., double hop).

The return single hop connection from the second remote site 14 back to the first remote site 18 is setup in a similar manner.

A time out is used to determine an end of call (i.e., no activity for a pre-determined duration) at which point the single hop server 52 is informed. If there were multiple routes using the single hop link, it modifies the IP HDLC address for the route requesting termination at the transmit end to revert to the operator configured value, thus causing the traffic to flow back to the hub site 12. If it was the last route, in addition to reconfiguring the transmit end to use the pre-configured IF HDLC address, it also disables the receiver IP modem 50 so that it does not receive unintended traffic.

The single hop server 52 is also capable of increasing and decreasing the transmit power level of the transmitted carrier from a remote site 14 to another remote site 14 to compensate for the smaller antenna at both of the remote sites 14. The transmit power level is increased at the start of the connection and reduced back to the original level at the end of the connection. The “power boost” feature takes into account total power availability at the satellite for the network 10 (it is set by the satellite operator based on the service contract). It does not exceed total power available and may use preemption to accommodate higher priority connections.

The on demand single hop connectivity option enables real-time applications that are delay and bandwidth sensitive. It allows a STAR topology network to dynamically change to a partial MESH or even a full MESH topology in response to application demand. The STAR network seamlessly converts to a partial MESH or even a full MESH topology and then reverts to the STAR topology while carrying its full complement of traffic. The transition from double hop to single hop and then back to double hop is “hitless” for almost all the application. It further alleviates the need for twice the bandwidth for remote site 14 to remote site 14 connectivity.

The present system and method provide many other advantages over the prior art frame relay based systems. The network is highly integrated and does not require a separate FRAD and modem. This reduces the complexity of the network thereby increasing reliability and maximizing space allocation. Since the network 10 does not require certain components associated with frame relay, the cost of the network 10 is lower than the prior art networks. By having QoS control by IP addresses with the option of permissive or restrictive mode, this allows for better control over bandwidth provisioning to different applications based on their delay and jitter tolerance. The network 10 further allows for encrypting on an IP route basis for security. The network 10 further improves bandwidth utilization. Furthermore, NAT enabled use of private IP addresses at the remote site 14 allows for efficient network designs without worrying about available public IP addresses.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A network system having STAR topology comprising:
a hub site; and
at least one remote site;
wherein call control and management between the hub site and the remote site use Internet Protocol (IP) addressing and HDLC addressing at the link level for identification thereby allowing only a desired remote site to read data transmitted.

2. The network system of claim 1 further comprising a plurality of remote sites.

3. The network system of claim 2 further comprising:
a first communication channel to transmit data to the plurality of remote sites; and
a plurality of second communication channels to transmit data from the plurality of remote sites to the hub.

4. The network of claim 1 wherein the hub site comprises:
a first IP modem for receiving and transmitting data to and from the hub site and for maintaining a network database; and
at least a second IP modem for receiving data from a remote site.

5. The network of claim 1 wherein the at least one remote site comprises a remote modem for continuously receiving data from the hub site and for transmitting data when required.

6. A network system comprising:
a hub site;
a plurality of remote sites; and
a satellite for transmitting data to and from the hub site and the remote site;
wherein call control and management between the hub site and the remote site use Internet Protocol (IP) addressing and HDLC addressing for identification.

7. A network system in accordance with claim 6 wherein the plurality of channels comprises:
a first communication channel to transmit data to the plurality of remote sites; and
a plurality of second communication channels to transmit data from the plurality of remote sites to the hub.

8. The network of claim 7 wherein the hub site comprises:
a first IP modem for receiving and transmitting data to and from the hub site and for maintaining a network database; and
at least one second IP modem for receiving data from a remote site.

9. The network of claim 7 wherein each of the plurality of remote sites comprises a remote modem for continuously receiving data from the hub site and for transmitting data when required.

10. The network of claim 7 wherein the data base stored in the first IP modem maintains a listing of all the plurality of channels in the network; a listing of destination IP addresses and destination HDLC addresses for each of the plurality of channels; a listing of a guaranteed minimum available bandwidth of each of the plurality of channels and a listing of a maximum allowable bandwidth of each of the plurality of channels.

11. The network of claim 10 wherein the data base stored in the primary network control modem maintains a listing of encryption capability of each channel.

12. A network system having STAR topology and which allows on demand single hop connectivity between remote sites comprising:
a hub site;
a plurality of remote sites;
a first channel for sending data from the hub site to all of the plurality of remote sites;
a plurality of second channels for transmitting data from each of the plurality of remote sites to the hub site and for transmitting data between the plurality of remote sites;
wherein call control and management between the hub site and the remote sites and between different remote sites use Internet Protocol (IP) addressing for identification.

13. The network of claim 12 wherein the hub site comprises:
a first IP modem for receiving and transmitting data to and from the hub site and for maintaining a network database;
at least a second IP modem for receiving data from a remote site; and
a single hop server for configuring channels to transmit data directly between different remote sites.

14. The network of claim 12 wherein each of the plurality of remote sites comprises:
a first remote modem for continuously receiving data from the hub site and for transmitting data when required; and
a second remote modem for receiving data sent from a different remote site.

15. A method for allowing a network system having STAR topology to perform on demand single hop connectivity between remote sites comprising the steps of:
providing a single hop server at a hub site of the network system;
providing a first remote modem at each remote site for continuously receiving data from the hub site and for transmitting data when required;
providing a second remote modem at each remote site that receives data from a second remote site for receiving data sent from a different remote site;
configuring the network so call control and management between the hub site and the remote sites and between different remote sites use Internet Protocol (IP) addressing for identification; and
configuring a direct channel between remote sites that are communicating to transmit the data.

16. The method of claim 15 wherein the step of configuring a direct channel between remote sites that are communicating comprises the steps of:
sending a signal from a first remote site to the hub site requesting a single hop connection to a second remote site;
checking by the hub site to see if the second remote site is tuned to a carrier being transmitted by the first remote site;
selecting an HDLC address from an available range;
configuring the second remote site to add the selected IP HDLC address for receiving data; and
configuring the first remote site to start using the selected IP HDLC address.

17. The method of claim 15 wherein the step of configuring a direct channel between remote sites that are communicating comprises the steps of using an existing HDLC address when the second remote site is configured to receive a maximum number of HDLC addresses.

18. The method of claim 15 further comprising the step of monitoring for a timeout to determine an end of transmitting data.

19. The method of claim 15 wherein the single hop server can preempt an existing connection to allow a higher priority connection to proceed.

20. The method of claim 15 wherein the single hop server can queue a request until a remote modem at a desired remote site becomes available.

21. The method of claim 15 wherein the network system seamlessly changes topology to support application demand without human intervention and without causing loss of connectivity for current traffic.

22. The method of claim 15 wherein the single hop server can dynamically adjust transmit power of a carrier for single-hop remote to remote connection to compensate for smaller antenna size at the remote sites.
